(19) United States
(12) Patent Application Publication
(10) Pub. No.: US 2008/0020191 A1
(43) Pub. Date: Jan. 24, 2008

(54) MONOAXIALLY ORIENTED POLYPROPYLENE FILM WITH HIGH TRANSVERSE TEAR PROPAGATION RESISTANCE

(75) Inventors: Bernhard Mussig, Seevetal (DE); Steffen Kammerer, Frankfurt am Main (DE)

Correspondence Address: NORRIS, MCLAUGHLIN & MARCUS, P.A., 875 THIRD AVE, 18TH FLOOR, NEW YORK, NY, 10022, US

(73) Assignee: tesa Aktiengesellschaft, Hamburg (DE)

(21) Appl. No.: 11/564,097

(22) Filed: Nov. 28, 2006

(30) Foreign Application Priority Data
Jul. 21, 2006 (DE) 10 2006 034 252.6

(51) Int. Cl. B32B 27/32; B29C 47/88; B32B 7/12

(52) U.S. Cl. 428/220; 264/211.12; 428/343; 428/409; 428/521

(57) ABSTRACT

Backing film which comprises at least one polypropylene and has been longitudinally monoaxially oriented, characterized in that at least one nucleating agent has been inhomogeneously distributed in the backing film.

The invention relates to a backing film composed of polypropylene, to processes for production of the same and to the use thereof in an adhesive tape.

Films with high longitudinal strength are usually obtained via orientation of flat extruded films composed of semicrystalline thermoplastics. This is mainly biaxial orientation, but in exceptional cases, for further increase of longitudinal strength, the films have only longitudinal orientation. However, polypropylene-based films commonly available in the market, both biaxially or else monoaxially oriented, have low transverse tear propagation resistances when compared with unoriented films from the blowing process or casting process. Under practical conditions, damaged edges of the film or of the adhesive tape (caused by blunt knives during cutting or during subsequent unintended damage to the cut edge) easily lead to tearing or break-off under tension.

When requirements for tensile strength and tear propagation resistance are stringent, films or adhesive tapes are reinforced with filaments or networks composed of filaments composed of glass or plastic. The production of these filament adhesive tapes is very complicated in terms of plant and therefore expensive and unreliable. Alongside the base film, the filaments and lamination adhesives (or an additional pressure-sensitive-adhesive coating) are needed, and this further increases the cost of the products. Other disadvantages of these filament adhesive tapes are low crease fracture resistance, high thickness, lack of clean cut edges, and shortcomings in through-weldability and in recyclability. The production process is described by way of example in U.S. Pat. No. 4,454,192 A.

DE 21 04 817 A1 describes a process for production of an adhesive tape backing composed of polyolefin (polyethylene or polypropylene). It is said to be possible to achieve a longitudinal tensile strength of 320 N/mm² (according to a preferred embodiment) via longitudinal stretching. There is no disclosure of stretching ratio or tensile stress value achieved at 10% tensile strain.

The subject matter of EP 0 255 866 A1 is a longitudinally stretched or biaxially stretched polypropylene film composed of a polypropylene homopolymer or of a polypropylene copolymer. Addition of elastomeric components increases transverse tensile impact resistance. However, this measure impairs tensile strength and tear propagation resistance in the transverse direction, since it suppresses the formation of fibrous structures during transverse loading of the film. The longitudinal stretching ratio is from 1:5.5 to 1:7. Tensile strengths achieved are from 12 to 355 N/mm². Values for the tensile stresses at 10% tensile strain are not disclosed.

DE 36 40 861 A1 describes a tear strip with reduced susceptibility to break-off via use of a longitudinally oriented film produced via coextrusion of polymers of different toughness. The tough coextrusion layer reduces formation of microcracks during cutting of the product and thus improves resistance to lateral tearing. However, it does not avoid break-offs at edges subsequently damaged. The polymers stated as main component of the coextrusion layer serve to increase the toughness of this layer, but also lead to markedly reduced longitudinal tensile strength of the films. The calculation to convert the values given results in only 215 N/mm² for the tensile strength of the films described in the examples. This results from the combination of PP block copolymer having at most 20% of ethylene and impact modifier in the mixing specification. LLDPE, EVA and SBS rubber are mentioned as impact modifier. They are present in various ratios in the two layers, in order to obtain a layer which has high toughness and retains relatively good strength. The strip does not have high transverse tear propagation resistance. The stretching ratio is 1:7.5. The tensile stress values at 10% tensile strain are from 84 to 103 N/mm² and the tensile strengths are in the range from 196 to 214 N/mm².

DE 44 02 444 A1 relates to a tear-resistant adhesive tape based on monoaxially oriented polyethylene. The mechanical properties that can be obtained are in some respects similar to those of corresponding polypropylene products. However, polyethylene has markedly lower heat resistance than PP, and this can have a disadvantageous effect not only during the production of the adhesive tape (drying of adhesive layers or of other layers in the oven) but also during the subsequent packaging applications as grip tape, carton-sealing adhesive tape, tear strip or carton-reinforcing strip. The adhesive tapes on the cartons often become hot, for example during passage through printing machines or after filling with hot products (e.g. foods). Another disadvantage of polyethylene films (including oriented films) is that the force for 10% tensile strain is markedly lower in comparison with polypropylene films, as is known to the person skilled in the art and as also found on checking the cited commercially available films. The result of the higher tensile strain for a given force is that carton-sealing adhesive tapes or grip tapes produced therefrom tend to release when subjected to tensile load and cannot prevent the tearing of cartons. There is no disclosure of the longitudinal stretching ratio or of tensile stresses for 10% tensile strain. The tensile strengths achieved are from 102 to 377 N/mm².

The products described above have certainly found applications, but cannot approach the tensile strengths and tear propagation resistances of filament adhesive tapes. There have therefore been attempts to avoid the complicated application of a large number of filament threads and to give the oriented films filament-like properties via longitudinal structures, and these are described below.

U.S. Pat. No. 5,145,544 A and U.S. Pat. No. 5,173,141 A describe an adhesive tape composed of a monoaxially oriented film which has a rib structure for reinforcement, where the ribs in part protrude from the surface, and in part have been embedded into the film surface, there being notches between film and ribs. The film achieves high lateral tear resistance, but in contrast tensile strength and extensibility requiring improvement. However, the significant shortcoming is that full-scale production of that type of film is impossible. The reasons for this are poor orientability at conventional width and also extremely poor layflat, the result being uncertain coatability with pressure-sensitive adhesive. Another factor causing impaired layflat at high widths is non-uniform and inadequate adhesion (the consequence of the failure of the film to lay flat) on the stretching rolls in the subsequent orientation process. During production at the width conventionally produced, the central region of the film is transversely held on the stretching rolls, and therefore the rib structure alters through orientation, and the overall quality of the product becomes inhomogeneous. Another disadvantage is the need for at least 50% embedment of the ribs via a calender, which incurs major capital expenditure and makes the process much more complicated. The rib structure on the surface also easily leads to coating defects during application of release agents or primers on further processing to give adhesive tapes, since the application processes for films require a smooth surface. Imprints of reinforcing filaments or rib structures in the surface of films are a disadvantage for printing, precondition of which are smooth surfaces. Particularly for use of the film for a packaging adhesive tape, printability is an important criterion for the customer. A stretching ratio of 1:7 and tensile strengths of from 157 to 177 N/mm² can be found in U.S. Pat. No. 5,145,544 A, but no tensile stress values at 10% tensile strain are found. Stretching ratios of from 1:6.1 to 1:7 and tensile strengths of up to 245 N/mm² can be found in U.S. Pat. No. 5,173,141 A, but no tensile stress values at 10% tensile strain are found.

EP 1 101 808 A1 attempts to eliminate the disadvantages mentioned by laying the rib structures into the interior of the film. The film has plane parallel outer sides and comprises at least two coextruded layers of different composition whose interface is not level but has, in cross section, an uneven boundary line, which proceeds longitudinally in laminar fashion. The basis of the particular internal structure of the film is that the thickness of one layer varies periodically or irregularly in a transverse direction and the second layer compensates for the thickness variations in such a way as to keep the total thickness in essence constant.

All of the films mentioned have, where compared with a normal adhesive tape film, improved tensile strength and improved longitudinal modulus of elasticity. The stretching ratios are from 1:6.7 to 1:8.7. The tensile strengths achieved are from 202 to 231 N/mm² and the tensile stress values achieved for 10% tensile strain are from 103 to 147 N/mm².

EP 0 353 907 A1 applies the idea of fibrillation of films. In this, an adhesive tape is produced from a backing layer which is adhesive-bonded to another layer of a fibrillated polymer film. The fibrillated side is then coated with adhesive material. The polymer film to be fibrillated is preferably extruded, and composed of PP, and is then monoaxially stretched in the machine direction. This process, which is likewise very complicated, has the disadvantage that the laminate has to be produced in four steps of a process (extrusion, stretching, fibrillation and adhesive-bonding of the fibrils to the BOPP backing film).

The thickness of the films of EP 0 353 907 A1 is about 25 μm (BOPP) and about 5 μm (oriented PP film). The ultimate tensile strengths that can be achieved are therefore only from 99 to 176 N/cm and the tear propagation resistances that can be achieved are therefore only from 15 to 22 N/cm.

None of these films has achieved large-scale production, since the production processes are very complicated. Secondly, their properties are far inferior to those of products with glass filaments or with polyester filaments.

It is an object of the invention to provide a backing film which does not exhibit the disadvantages described of the prior art, or exhibits these to a lesser extent. In particular, the intention is that these have high transverse tear propagation resistance and are non-transparent.

This object is achieved via a backing film as set out in the main claim. The subject matter of the subclaims here is advantageous embodiments of the backing film, processes for production of the same, and also possible uses.

Accordingly, the invention provides a backing film which comprises at least one polypropylene and which has been longitudinally monoaxially oriented. It is important for the invention that at least one nucleating agent has been inhomogeneously distributed in the backing film.

Because of the inventive combination of a nucleating agent inhomogeneously distributed in the film with monoaxial orientation, the film has a mother-of-pearl appearance and is white unless additional pigments or dyes are added.

Nucleating agents (salts of organic acids, e.g. sodium benzoate) are added to crystallizable thermoplastics, specifically to polyolefins, polyesters, polyamides, etc., to accelerate crystallization. The alteration of the crystallization process gives products with altered physical property profile.

In one advantageous embodiment of the invention, the haze of the backing film is at least 40%, preferably at least 45%, and/or its gloss is less than 60%, preferably less than 40%. The test methods for determination of these values are explained below.

In order to achieve high tensile strengths, high values for tensile stress at 1% and 10% tensile strain, and high tear propagation resistance, the stretching process conditions are preferably selected so that the stretching ratio is in each case the maximum ratio industrially feasible for the primary film. According to another advantageous embodiment of this invention, the longitudinal stretching ratio is at least 1:8, preferably at least 1:9.5. The stretching ratio states that, for a stretching ratio of 1:8, a section of the film of length, for example, 1 m produces a section of the stretched film of length 8 m. The stretching ratio is also often defined as the quotient calculated from the line velocity and the stretching roll velocity.

In another preferred embodiment, the value for tensile stress at 1% tensile strain of the backing film in the machine direction is at least 20 N/mm², preferably at least 40 N/mm², and/or its value for tensile stress at 10% tensile strain is at least 250 n/mm², preferably at least 300 N/mm².

Further preference is given to tensile strength of at least 300 N/mm², particularly preferably at least 350 N/mm².

The transverse tear propagation resistance, based on film thickness, preferably reaches at least 450 N/mm².

To calculate strength values, the force values based on width are divided by the thickness. In the case of determination of an adhesive tape produced with the backing film the thickness used as a basis for the calculation is not to be the total thickness but only the thickness of the backing film.

The thickness of the backing film is preferably from 25 to 200 μm, particularly preferably from 40 to 140 μm, very particularly preferably from 50 to 90 μm.

According to this invention, suitable film polymers are commercially available polypropylene homopolymers or polypropylene copolymers. The melt indices of the abovementioned polymers should be in the region suitable for flat-film extrusion. According to one preferred embodiment, this region is from 0.3 to 15 g/10 min, preference being given to the region from 0.8 to 5 g/10 min (measured at 230° C./2.16 kg).

According to another advantageous embodiment, the flexural modulus is at least 1000 MPa, preferably at least 1500 MPa, more preferably at least 2000 MPa.

The structure of the polypropylene is preferably mainly isotactic.

The polymers for forming the backing film can be straight polymers or blends with additives, for example with antioxidants, light stabilizers, antiblocking agents, lubricants and processing aids, fillers, dyes or pigments.

The mother-of-pearl appearance is achieved as described via addition of nucleating agents.

Barium sulphate can be used as nucleating agent.

In principle it is possible to use any of the nucleating agents suitable for polypropylene. Particularly suitable nucleating agents are those which produce α crystals or β crystals. These are, for example, fillers with nucleating action, e.g. magnesium hydroxide, talc, kaolin, titanium dioxide or silica gel. It is preferable to use organic nucleating agents, for example benzoates, phosphates or sorbitol derivatives.

These nucleating agents are described, for example, in the Chapter 9.1. Nucleating Agents in Ullmann's Encyclopaedia of Industrial Chemistry (2002 Edition from Wiley-VCH Verlag, Article Online Posting Date Jun. 15, 2000) or in the examples of US 2003195300 A1 (U.S. Pat. No. 6,927,256 B). Another suitable measure consists in the use of a semicrystalline branched or coupled polymeric nucleating agent as described in US 2003195300 A1, for example a 4,4′-oxydibenzenesulphonylazide-modified polypropylene.

The nucleating agent used can be pure or take the form of a masterbatch.

The preferred process for production of the backing film or of an adhesive tape which uses the inventive backing film includes the following steps:
Polymers and additives are mixed and, in an extruder, introduced into a flat-film die, the extruder providing non-homogeneous mixing of the nucleating agent with the polypropylene.
The melt film is then subjected to controlled cooling on what is known as a chill roll.
Before the film is introduced into the stretching unit, it is heated by way of temperature-controlled rolls to a suitable stretching temperature.
The film is oriented in the narrow-gap system in the machine direction.
The backing film is, if appropriate, provided with an adhesive mass via coating or coextrusion.

It is preferable that the screw of the extruder does not comprise an excessive number of mixing elements or comprise mixing elements having too intensive an action, since otherwise there is a risk that the nucleating agent is too homogeneously distributed.

The production process can be controlled with greater reliability if production of the backing uses a mixture in which a non-nucleated polyolefin is used alongside the nucleated polypropylene. The mixture is preferably composed of a nucleated and a non-nucleated polypropylene.

The film produced can have one or more layers, and is preferably a one-layer film. The films may have undergone modification via lamination, embossing, or radiation treatment.

The unoriented primary film with the nucleating agents does not have a mother-of-pearl appearance. This is not produced until the material has been longitudinally oriented.

The normal appearance of the film is mother-of-pearl white. It is also possible to produce coloured films of mother-of-pearl type and, respectively, adhesive tapes therefrom, for example in a gold or copper shade, via addition of pigments or appropriate dyes during film production or via coloured coating of the film.

The films may have been provided with surface treatments. Examples of these treatments are, for adhesion promotion, corona-treatment, flame-treatment, fluorine-treatment or plasma-treatment, or coatings of solutions, of dispersions or of liquid radiation-curable materials. Other possible coatings are prints and anti-adhesion coatings, for example those composed of crosslinked silicones, acrylates (e.g. Primal® 205), polymers having vinylidene chloride or vinyl chloride as monomer or stearyl compounds, such as polyvinyl stearylcarbamate or chromium stearate complexes (for example Quilon® C) or reaction products of maleic anhydride copolymers and stearylamine.

It is preferable to provide an adhesive mass on one or both sides of the backing film, preferably a self-adhesive or heat-activatable adhesive layer.

The general expression “adhesive tape” encompasses any of the flat articles such as two-dimensional films or film sections, tapes with extended length and restricted width, tape sections, punched sections, labels and the like.

The adhesive mass preferably involves pressure-sensitive adhesive.

For the adhesive tape application, one or both sides of the film is/are coated with the preferred pressure-sensitive adhesive in the form of a solution or dispersion or undiluted (e.g. melt) or via coextrusion with the film. The adhesive layer(s) can be crosslinked via heat or high-energy radiation and, if necessary, protectively covered with release film or release paper. Suitable pressure-sensitive adhesives are described in D. Satas, Handbook of Pressure Sensitive Adhesive Technology (Van Nostrand Reinhold).

Particularly suitable pressure-sensitive adhesives are those based on acrylate, on natural rubber, on thermoplastic styrene block copolymer, or on silicone.

For optimization of properties, the self-adhesive mass used can preferably be blended with one or more additives, such as tackifiers (resins), plasticizers, fillers, pigments, UV absorbers, light stabilizers, antioxidants, crosslinking agents, crosslinking promoters, or elastomers.

Examples of suitable elastomers for the blending process are EPDM rubber or EPM rubber, polyisobutylene, butyl rubber, ethylene-vinyl acetate, hydrogenated block copolymers composed of dienes (e.g. via hydrogenation of SBR, cSBR, BAN, NBR, SBS, SIS or IR, these polymers being known as, for example SEPS and SEBS) or acrylate copolymers, such as ACM.

Examples of tackifiers are hydrocarbon resins (for example derived from unsaturated C₅ or C₇ monomers), terpene phenol resins, terpene resins derived from raw materials such as α- or β-pinene, aromatic resins, such as cumarone-indene resins or resins derived from styrene or α-methylstyrene, e.g. colophonium and its downstream products, such as disproportionated, dimerized or esterified resins, and glycols, glycerol or pentaerythritol can be used here, as also can other materials as listed in Ullmanns Enzyklopädie der technischen chemie [Ullmann's Encyclopedia of Industrial Chemistry], Volume 12, pages 525-555 (4th Edition), Weinheim. Oxidation-resistant resins with no olefinic double bond are particularly suitable, examples being hydrogenated resins.

Examples of suitable fillers and pigments are carbon black, titanium dioxide, calcium carbonate, zinc carbonate, zinc oxide, silicates or silica.

Suitable UV absorbers, light stabilizers and antioxidants for the adhesive masses are the same as those listed for stabilization of the film.

Examples of suitable plasticizers are aliphatic, cycloaliphatic and aromatic mineral oils, di- or polyesters of phthalic acid, trimellitic acid or adipic acid, liquid rubbers (e.g. nitrile rubbers or polyisoprene rubbers), liquid polymers composed of butene and/or isobutene, acrylic esters, polyvinyl ethers, liquid and plasticizing resins based on the raw materials for adhesive resins, lanoline and other waxes, or liquid silicones.

Examples of crosslinking agents are phenolic resins or halogenated phenolic resins, melamine resins and formaldehyde resins. Examples of suitable crosslinking promoters are maleimides, allyl esters, such as triallyl cyanurate, polyfunctional esters of acrylic acid and of methacrylic acid.

One preferred embodiment of the adhesive mass comprises a pressure-sensitive adhesive composed of natural rubber, hydrocarbon resin and antioxidant.

The adhesive-mass coating thickness is preferably in the range from 18 to 50 g/m², in particular from 22 to 29 g/m². The width of the adhesive tape rolls is preferably in the range from 2 to 60 mm.

The inventive backing film is particularly suitable for high-quality attractive packaging applications. In the prior art there are no known backing films which are monoaxially longitudinally oriented and which have this (white) mother-of-pearl appearance. White monoaxially oriented backing films have hitherto been produced only via addition of titanium dioxide. The only materials known from the packaging industry which have this inventive appearance are biaxially oriented films. This appearance is achieved via addition of fillers or of blowing agents which form small cavities in the films.

In one preferred embodiment, the film has high tensile strength and high value for tensile stress at 10% tensile strain. The orientation of the film is preferably sufficiently marked to give very low transverse tensile impact resistance. This can be disadvantageous for some applications, such as tear strips or carton sealing, but it has proven advantageous for applications such as reinforcement of punched areas on cartons. Low tensile strain via a high degree of longitudinal orientation avoids the tearing of carton board (for example at punched-out carry grips). Films of this type have a tendency toward longitudinal fiberization, which in the event of edge damage inhibits transverse tear propagation by diverting the tear longitudinally.

In contrast to the process described in EP 0 353 907A1, the backing film can be produced on a plant in-line in only two steps (extrusion, stretching), and moreover has much higher transverse tear propagation resistance (about 300 N/cm at 70 μm thickness).

### Test Methods

Thickness: DIN 53370
Tensile strength: DIN 53455-7-5, longitudinal
Tensile stress at 1% or 10% tensile strain: DIN 53455-7-5, longitudinal
Tensile strain break: DIN 53455-7-5, longitudinal
Gloss: DIN 67530, angle: 60°
Haze: ASTM D 1003
Transverse tensile impact resistance: DIN EN ISO 8256 (clamped length 10 mm, 7.5 J pendulum, 5 laps, 30 g yoke)
Transverse tear propagation resistance: based on DIN 53363-2003-10, with the following modifications:
   Film width 10 mm. Because of the incision depth of 5 mm, the effective width of the test specimens is therefore also 5 mm
   The angle of the marking for the clamps with respect to the film edge is 75°
   For better differentiation of the specimens in terms of their transverse tear propagation resistance, the test velocity was increased from 100 to 2000 mm/min. This also permitted more precise differentiation of the fracture behaviour of the specimens, on the basis of type of failure.

### Since the samples produced have different thickness, tear propagation resistance is standardized with respect to thickness and stated in N/mm².

### Failure Criterion

The films can be categorized with respect to their type of failure, and this can likewise be utilized as a quality criterion for transverse tear propagation resistance:
a) The tear in the specimen simply propagates transversely until the test specimen fails by fracture. This is regarded as the most disadvantageous case for assessment of transverse tear propagation resistance.
b) A tear in the specimen initially propagates longitudinally until the clamps are reached, and then the specimen tears transversely with respect to the test direction on reaching the ultimate tensile strength. This tear behaviour is an indicator of high transverse tear propagation resistance of the film.
c) The tear in the specimen initially propagates longitudinally until the clamps are reached, and then the specimen tears with splitting longitudinally on reaching the ultimate tensile strength to give a large number of individual fibres, which then finally tear transversely. This tear behaviour is an indicator of high transverse tear propagation resistance of the film, tear propagation resistance being slightly higher than for failure type b).
Melt index: DIN 53735 (PP 230° C., 2.16 N)
Flexural modulus ASTM D790 A
Adhesive data: AFERA 4001, corresponding to DIN EN 1939

### Examples will be used below to illustrate the invention, but without any intention that the invention be restricted thereby.

### EXAMPLES

Raw Materials:

Dow 7C06: PP block copolymer, MFl 1.5 g/10 min, non-nucleated, flexural modulus 1280 MPa (Dow Chemical)

BA 110 CF: PP block copolymer, MFl 0.85 g/10 min, non-nucleated, flexural modulus 1200 MPa (Borealis)

Moplen HP 501 D: homopolymer, MFl 0.7 g/10 min, non-nucleated, flexural modulus 1450 MPa (Basell)

Bormod HD 905: homopolymer, MFl 6 g/10 min, flexural modulus 2150 MPa (Basell), comprising according to our analysis a phosphate-based α-nucleating agent, probably ADK STAB NA-11 (Adeka Palmarole)

Inspire D 404.01: MFl 3 g/10 min, nucleated, flexural modulus 2068 MPa (Dow Chemical), nucleated (with a polymeric nucleating agent corresponding to US2003195300 A1)

BNX BETAPP-N: β-nucleating agent in polypropylene, MFl 4 g/10 min (Mayzo)

Millad® 3988: 1,3:2,4-bis(3,4-dimethylbenzylidene)sorbitol (Millad Chemical) [nucleating agent]

Remafingelb HG AE 30; PP colour masterbatch with translucent pigment (Clariant Masterbatches)

### Inventive Example 1

The film was produced in one layer on a single-screw extrusion plant with flat-film die with flexible die lip, followed by chill-roll unit and by a single-stage narrow-gap stretching system.

Inspire D 404.01 and Dow 7C06 were mixed in a ratio of 1:1 and extruded. The die temperature was 235° C. Chill roll temperatures and stretching roll temperatures were set in such a way as to maximize the crystallinity of the film prior to and after the stretching procedure.

The stretching ratio was 1:10.

Film properties:

| Backing thickness after stretching | 80 μm |
|---|---|
| Tensile stress at 1% tensile strain | 43 |
| Tensile stress at 10% tensile strain | 340 |
| Tensile strength | 373 N/mm² |
| Tensile strain at break | 22% |
| Tear propagation resistance | 520 N/mm² |
| Failure criterion | 3. |
| Transverse tensile impact resistance | 63 mJ/mm² |
| Colour | mother-of-pearl white |
| Haze | 49.8% |
| Gloss | 28.7% |

The film was corona-pretreated on both sides, coated on the upper side with a 0.5% strength solution of PVSC in toluene as release system, and dried. The adhesive was mixed from 42% by weight of SIS elastomer, 20% by weight of pentaerythritol ester of hydrogenated colophonium, 37% by weight of a C₅ hydrocarbon resin whose R&B value was 85° C. and 1% by weight of Irganox® 1010 antioxidant in the melt, and was applied at 150° C. to the lower side of the film, using a die. The adhesive tape was then wound onto the parent roll and cut to 15 mm width for further testing.

Adhesive data:

| | |
|---|---|
| Adhesion to steel | 2.05 N/cm |
| Unwind force at 0.3 m/min | 0.9 N/cm |
| Weight applied | 22 g/m² |

### Inventive Example 2

The film was produced by analogy with Inventive Example 1, but the stretching ratio was set at 1:8. The raw materials selected comprised a mixture composed of 98.9 parts by weight of Moplen HP 501 D, 0.9 part by weight of Remafingelb HG AE 30 and 0.2 part by weight of BNX BETAPP-N.

Film properties:

| Backing thickness after stretching | 60 μm |
|---|---|
| Tensile stress at 1% tensile strain | 36 N/mm² |
| Tensile stress at 10% tensile strain | 266 N/mm² |
| Tensile strength | 313 N/mm² |
| Tensile strain at break | 33% |
| Failure criterion | 2. |
| Transverse tensile impact resistance | 150 mJ/mm² |
| Colour | golden yellow mother-of-pearl |
| Haze | 53% |
| Gloss | 26.1% |

The film was corona-pretreated on both sides, and coated on the upper side with a solvent-free silicone, which was then crosslinked by UV radiation. The lower side was provided with a primer composed of natural rubber, cyclorubber and 4,4′-diisocyanato-diphenylmethane. The adhesive was dissolved in hexane in a kneader, using 40% by weight of SMRL natural rubber (Mooney 70), 10% by weight of titanium dioxide, 37% by weight of a C₅ hydrocarbon resin whose R&B value was 95° C. and 1% by weight of Vulkanox® BKF antioxidant. The 20% strength by weight adhesive mass was applied to the primed lower side of the film, using a spreader bar, and dried at 115° C. The adhesive tape was then wound onto the parent roll and cut to 15 mm width for further testing.

Adhesive data:

| | |
|---|---|
| Adhesion to steel | 1.9 N/cm |
| Unwind force at 0.3 m/min | 0.2 N/cm |
| Weight applied | 24 g/m² |

### Inventive Example 3

The film was produced by analogy with Inventive Example 1. The raw materials used comprised a mixture composed of 50 parts by weight of BA 110 CF and 50 parts by weight of Bormod HD 905.

The colour of the resultant film is mother-of-pearl white.

### Inventive Example 4

The film was produced by analogy with Inventive Example 1. The raw materials used comprised a mixture composed of 98 parts by weight of Dow 7C06 and 2 parts by weight of a masterbatch composed of 90% by weight of PP homopolymer and 10% of Millad® 3988.

The colour of the resultant film is mother-of-pearl white.

### Comparative Example 1

A film and an adhesive tape were produced by analogy with Inventive Example 1 from Dow 7C06 with a stretching ratio of 1:6.1.

Film properties:

| Backing thickness after stretching | 80 μm |
|---|---|
| Tensile strength | 247 N/mm² |
| Tensile stress at 1% tensile strain | 19 |
| Tensile stress at 10% tensile strain | 142 N/mm² |
| Tensile strain at break | 27% |
| Transverse tensile impact resistance | 258 mJ/mm² |
| Failure criterion | a) |
| Colour | colourless, slight haze |
| Haze | 36.9 |
| Gloss | 65.7 |

### Comparative Example 2

A film and an adhesive tape were produced by analogy with Inventive Example 1 from Inspire 404.01 with a stretching ratio of 1:10.

Film properties:

| Backing thickness after stretching | 70 μm |
|---|---|
| Tensile stress at 1% tensile strain | 71 |
| Tensile stress at 10% tensile strain | — |
| Tensile strength | 317 N/mm² |
| Tensile strain at break | 7% |
| Tear propagation resistance | 420 N/mm² |
| Failure criterion | c) |
| Transverse tensile impact resistance | 31 mJ/mm² |
| Colour | glass-clear |
| Haze | 3.5% |
| Gloss | 145.9% |

### Comparative Example 3

A film was produced by analogy with Inventive Example 1 from Moplen HP 501. The resultant film is colourless with low haze. The failure criterion is b).

### Comparative Example 4

Inspire D 404.01 and Dow 7C06 were mixed in a ratio of 1:1 and compounded in a twin-screw extruder with L/D ratio of 36. The resultant compounded material was further processed by analogy with Inventive Example 1.

Film properties:

| Failure criterion | b) |
|---|---|
| Colour | transparent |
| Haze | 12.5% |
| Gloss | 109.9% |

1. Backing film, which comprises at least one polypropylene and which is longitudinally monoaxially oriented, and wherein at least one nucleating agent is inhomogeneously distributed in the backing film.

2. Backing film, according to claim 1, wherein the haze of the backing film is at least 40%, or its gloss is less than 60%, or wherein its haze is at least 40% and its gloss is less than 60%.

3. Backing film according to claim 1 wherein the backing film has been longitudinally oriented with a stretching ratio of at least 1:8.

4. Backing film according to claim 1, wherein the longitudinal tensile strength of the backing film is at least 300 N/mm² or its transverse tear propagation resistance, based on the film thickness, is at least 450 N/mm², or wherein the backing film has both said tensile strength and said tear propagation resistance.

5. Backing film according to claim 1, wherein the value for longitudinal tensile stress at 1% tensile strain of the backing film is at least 20 N/mm² or its value for longitudinal tensile stress at 10% tensile strain is at least 250 N/mm² or both.

6. Backing film according to claim 1, wherein the thickness of the backing film is from 25 to 200 μm.

7. Backing film according to claim 1, wherein the backing film comprises a polypropylene whose melt index is from 0.3 to 15 g/10 min or whose flexural modulus is at least 1000 MPa or which has both said melt index and said flexural modulus.

8. Backing film according to claim 1, wherein the structure of the polypropylene is mainly isotactic.

9. Backing film according to claim 1, wherein the backing film is composed of a mixture of a nucleated and a non-nucleated polypropylene.

10. Backing film according to claim 1, wherein the nucleating agent is selected from the group consisting of magnesium hydroxide, talc, kaolin, titanium dioxide and silica gel, or is an organic nucleating agent, or is a semicrystalline branched or coupled polymeric nucleating agent.

11. Process for producing the backing film of claim 1, comprising the following steps:
polymers and additives are mixed and, in an extruder, introduced into a flat-film die, the extruder providing non-homogeneous mixing of the nucleating agent with the polypropylene,
the melt film is then subjected to controlled cooling on a chill roll,
before the film is introduced into the stretching unit, it is heated by way of temperature-controlled rolls,
the film is oriented in a narrow-gap system in the machine direction.

12. An adhesive tape having single- or double-side adhesion and the backing film of claim 1.

13. A method for reinforcement of cartons, which comprises reinforcing said cartons with a backing film of claim 1.

14. The backing film of claim 2, wherein said haze is at least 45% and said gloss is less than 40%.

15. The backing film of claim 3, wherein said stretching ratio is at least 1:9.5.

16. The backing film of claim 4, wherein said longitudinal tensile strength is at least 350 N/mm².

17. The backing film of claim 5, wherein said longitudinal tensile stress at 1% tensile strain of the backing film is at least 40 N/mm² and said value for longitudinal tensile stress at 10% tensile strain is at least 300 N/mm².

18. The backing film of claim 6, wherein said thickness is from 50 to 90 μm.

19. The backing film of claim 7, wherein said melt index is from 0.8 to 5 g/10 min and said flexural modulus is at least 2000 MPa.

20. The backing film of claim 10, wherein said nucleating agent is an organic nucleating agent, and said organic nucleating agent is a benzoate, phosphate, or a sorbitol derivative.
